(19) United States
(12) Patent Application Publication
(10) Pub. No.: US 2026/0169767 A1
(43) Pub. Date: Jun. 18, 2026

(54) AI-POWERED UI DESIGN TOOL

(71) Applicant: INTERNATIONAL BUSINESS MACHINES CORPORATION, Armonk, NY (US)

(72) Inventors: Hao Xiang Wu, Beijing (CN); Li Li Guan, Beijing (CN); Yan Jiang Li, Beijing (CN); Zhuo Zhao, Beijing (CN); Jing Quan, Beijing (CN); Ming Qian Wang, Xi'an City (CN)

(21) Appl. No.: 18/986,689

(22) Filed: Dec. 18, 2024

(51) Int. Cl. G06F 9/451

(52) U.S. Cl. CPC G06F 9/451

(57) ABSTRACT

A computer hardware system for generating a graphical user interface (GUI) design for an application includes a neural connected to an immutable memory and a mutable memory, and a hardware processor configured to initiate the following executable operations. An input defining requirements for the application is received. The immutable memory is populated using the requirements. The mutable memory is populated with previous component descriptions for UI components. A new component description for a UI component of the GUI is generated by the neural network using the immutable memory and the mutable memory and responsive to a prompt. The neural network is a neural Turing machine.

### BACKGROUND

The present invention relates to tools used for designing user interface (UI) design and development, and more specifically, a design tool employing an improved neural Turing machine.

There currently exists numerous AI-powered large language models (LLMs)—a type of neural network—that significantly enhance the efficiency of software development by acting as intelligent coding assistants. These tools utilize machine learning techniques to provide developers with code suggestions, auto-completion, and contextual help. However, similar LLM-based tools are lacking for UI design and development. This gap presents a challenge for application developers seeking efficient solutions to accelerate UI design processes.

In a conventional UI design and development process, designers are burdened with repetitive and time-consuming tasks—even when ample reference examples exist and are required to recreate designs from scratch using the company's design system, which hampers efficiency and creativity. Furthermore, developers often lack user interface (UX)/UI design knowledge and skills—leading to the use of wireframes to convey UI ideas. However, this approach often results in problems such as improper division of page functions and inconsistencies with the design system.

Current LLM models are capable of automatically generating textual descriptions of UI designs based on user requirements and user usage scenarios. However, the current approach has multiple limitations that make the generated UI design content almost unusable. One problem with the current approach is that the user can only adjust the output by fine-tuning the prompts being fed into the LLM model. Moreover, this fine-tuning can be naive in that the LLM model can respond to prompt adjustments in an unpredictable manner. Additionally, each page of the GUI has a particular technical design that defines that type of data to be displayed, and the output (i.e., data/content) provided by the LLM model can be random and not necessarily align with the data/content called for by the technical design. Yet another problem is that the output of the LLM models may be inconsistent with the design components found within the UI library of the design system.

### SUMMARY

A method is performed by a computer hardware system including a neural network connected to an immutable memory and a mutable memory to generate a graphical user interface (GUI) design for an application. An input defining requirements for the application is received. The immutable memory is populated using the requirements and a user interface (UI) component design library. The mutable memory is populated with previous component descriptions for UI components. A new component description for a UI component of the GUI is generated by the neural network using the immutable memory and the mutable memory and responsive to a prompt. The new component description is consistent with the UI component design library, and the neural network is a neural Turing machine.

Additionally, the methodology includes the new component description being generated using data from the immutable memory including historical design criteria, design system criteria, user interface (UX)/UI criteria, and application-related criteria. The requirements include application context and use case, example data for the GUI is generated from the use case, and a data model for the GUI is generated from the example data. The data model is used to generate the prompt for the neural network. Also, the generating the new component description for the UI component includes: identifying a previous version of the component description in the mutable memory, identifying, within the immutable memory, criteria associated with the UI component, constructing the prompt using the criteria associated with the UI component, and writing the new component description to the mutable memory. Feedback from a prior page design can also be used to construct the prompt, and the feedback from the prior page design includes at least one of: position conflict feedback, data model conflict feedback, and visual check feedback. A component description for a particular UI component includes: a position encoding that identifies a physical position of the particular UI component within the GUI, an identification of the particular UI component within the UI component design library, and a textual description of the particular UI component.

A computer hardware system for generating a graphical user interface (GUI) design for an application includes a neural network connected to an immutable memory and a mutable memory, and a hardware processor configured to initiate the following executable operations. An input defining requirements for the application is received. The immutable memory is populated using the requirements and a user interface (UI) component design library. The mutable memory is populated with previous component descriptions for UI components. A new component description for a UI component of the GUI is generated by the neural network using the immutable memory and the mutable memory and responsive to a prompt. The new component description is consistent with the UI component design library, and the neural network is a neural Turing machine.

Additionally, the system includes the new component description being generated using data from the immutable memory including historical design criteria, design system criteria, user interface (UX)/UI criteria, and application-related criteria. The requirements include application context and use case, example data for the GUI is generated from the use case, and a data model for the GUI is generated from the example data. The data model is used to generate the prompt for the neural network. Also, the generating the new component description for the UI component includes: identifying a previous version of the component description in the mutable memory, identifying, within the immutable memory, criteria associated with the UI component, constructing the prompt using the criteria associated with the UI component, and writing the new component description to the mutable memory. Feedback from a prior page design can also be used to construct the prompt, and the feedback from the prior page design includes at least one of: position conflict feedback, data model conflict feedback, and visual check feedback. A component description for a particular UI component includes: a position encoding that identifies a physical position of the particular UI component within the GUI, an identification of the particular UI component within the UI component design library, and a textual description of the particular UI component.

A computer program product comprises a computer readable storage medium having stored therein program code for generating a graphical user interface (GUI) design for an application. The program code, which when executed by a computer hardware system including a neural network connected to an immutable memory and a mutable memory, causes the computer hardware system to perform the following. An input defining requirements for the application is received. The immutable memory is populated using the requirements and a user interface (UI) component design library. The mutable memory is populated with previous component descriptions for UI components. A new component description for a UI component of the GUI is generated by the neural network using the immutable memory and the mutable memory and responsive to a prompt. The new component description is consistent with the UI component design library, and the neural network is a neural Turing machine.

Additionally, the compute program product includes the new component description being generated using data from the immutable memory including historical design criteria, design system criteria, user interface (UX)/UI criteria, and application-related criteria. The requirements include application context and use case, example data for the GUI is generated from the use case, and a data model for the GUI is generated from the example data. The data model is used to generate the prompt for the neural network. Also, the generating the new component description for the UI component includes: identifying a previous version of the component description in the mutable memory, identifying, within the immutable memory, criteria associated with the UI component, constructing the prompt using the criteria associated with the UI component, and writing the new component description to the mutable memory. Feedback from a prior page design can also be used to construct the prompt, and the feedback from the prior page design includes at least one of: position conflict feedback, data model conflict feedback, and visual check feedback. A component description for a particular UI component includes: a position encoding that identifies a physical position of the particular UI component within the GUI, an identification of the particular UI component within the UI component design library, and a textual description of the particular UI component.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture for a AI-powered design tool according to an embodiment of the present invention.

FIG. 2 is a block diagram illustrating a methodology of generating a graphical user interface (GUI) design for an application using the architecture of FIG. 1 according to an embodiment of the present invention.

FIG. 3 is a block diagram further illustrating the example architecture for a AI-powered design tool of FIG. 1 according to an embodiment of the present invention.

FIG. 4 is a block diagram illustrating a methodology of iteratively generating UI components descriptions for a GUI by a neural network using the architecture of FIGS. 1 and 3 according to an embodiment of the present invention.

FIG. 5 is a block diagram illustrating a format and form of an UI component description according to an embodiment of the present invention.

FIG. 6 is a block diagram illustrating an example of a computer environment for implementing portions of the methodology of FIG. 2.

### DETAILED DESCRIPTION

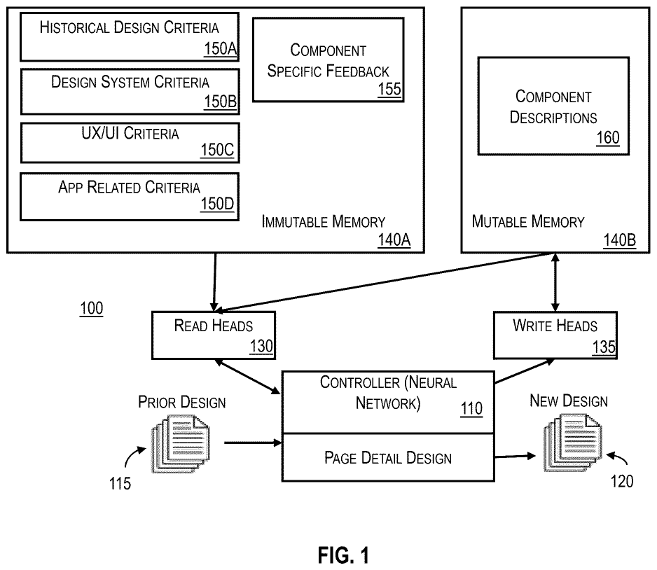

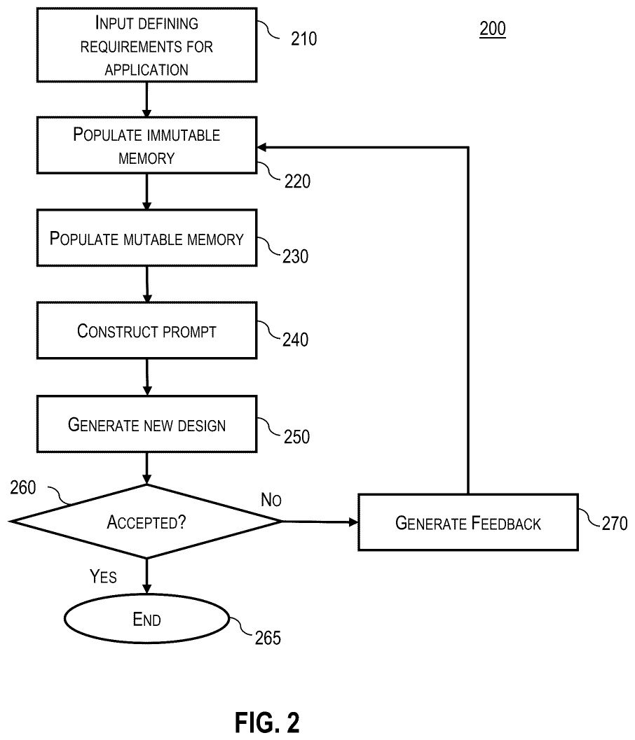

Referring to FIGS. 1 and 2, an AI-powered design tool 100 for generating a graphical user interface (GUI) design for an application and methodology 200 of using the same are illustrated. In certain aspects, the AI-powered design tool 100 employs deep learning using a neural network 110 that receives prior user interface (UI) designs 115 as input to generate new UI designs 120. As is commonly known, a neural network 110 is a machine learning program (model) that uses computing nodes in a manner that mimics the way biological neurons work together. In general, a neural network include layers of nodes (artificial neurons). These layers include an input layer, one or more hidden layers, and an output layer. Additionally, each node can connect to others and they have their own associated weight and threshold. Typically, neural networks use training data to learn.

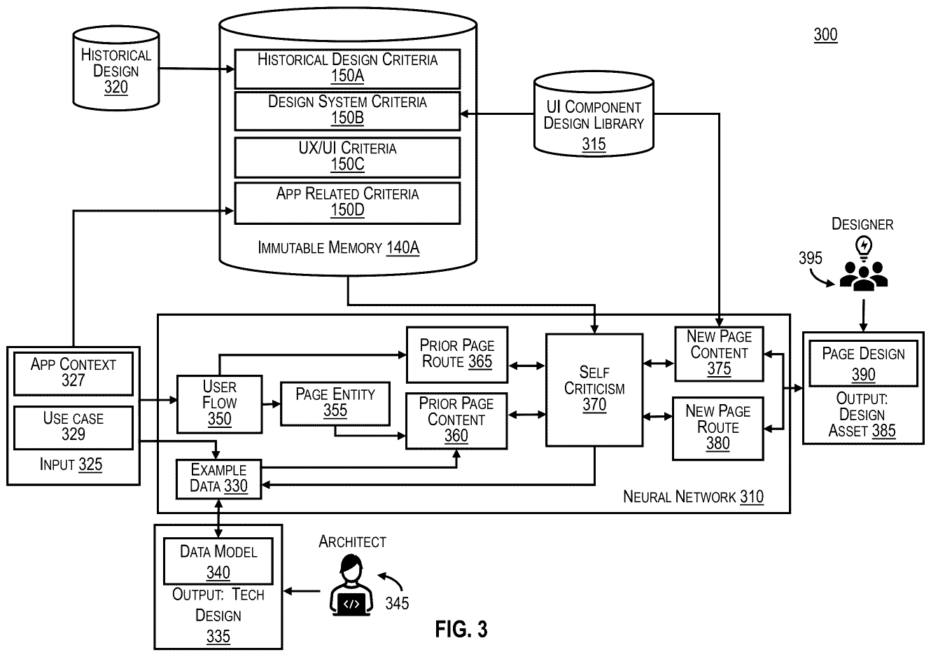

In operation and with reference to FIG. 2, an input defining requirements for the application is received. In 220, an immutable memory 140A is populated using the requirements for the application (e.g., application related criteria 150D). Other criteria such as historical design criteria 150A, design system criteria 150B (e.g., related to a user interface (UI) component design library 315 as illustrated in FIG. 3), and user interface (UX)/UI criteria 150C can also be contained within the immutable memory 140A. The mutable memory 140B is populated with previous component descriptions 160 for UI components of the GUI. In 240, a prompt is generated, and although not limited in this manner, the prompt can be generated using information regarding a prior design 115, which includes prior component descriptions 160 of the prior design 115 in addition to the criteria 150A-D stored within the immutable memory 140A, and component specific feedback 155 associated with the prior design 115. In 250, a new design 120 including a new component description 160 for a UI component of the GUI is generated by the neural network 110 using the immutable memory 140A and the mutable memory 140B and responsive to the prompt. During this operation, old component descriptions 160 in the mutable memory 140B can be rewritten with new component descriptions 160. In 260 a determination is made whether the new design 120 is acceptable or whether the new design 120 needs to be improved. If the new design 120 is acceptable, the methodology 200 proceeds to 265. Otherwise, feedback is generated in 270. The methodology 200 then returns to 230 in which the immutable memory 140A is populated with component specific feedback 155.

In the context of the present design tool 100, immutable memory 140A is memory that is only readable by the neural network 310, and the mutable memory 140B can be both written to and read by the neural network 310. As discussed below, the immutable memory 140A includes information (e.g., criteria 150A-150D) that is provided by other sources and component-specific feedback 155. However, those sources are not the neural network 310. In particular, the sources can include a database store of historical designs 320, the UI component design library 315, and the application context 327.

Many types of neural networks are known, and the design tool 100 is not limited as to a particular type. However, in certain aspects, the neural network 110 is a recurrent neural network (RNN). A RNN is a class of neural networks that includes weighted connections within a layer. A RNN can be distinguished from a traditional neural network by use of “memory,” which involves using information from prior inputs to influence the current input and output of the neural network. Many types of RNNs are known, and the present design tool 100 is not limited as to a particular type of RNN. For example, popular neural network architecture variants include bidirectional recurrent neural networks (BRRNs), long short-term memory (LTSM), gated recurrent units (GNUs), and encoder-decoder RNN. However, in certain aspects, the neural network 110 is part of a modified Neural Turning Machine (NTM) architecture.

As is known, a NTM is a working memory neural network model that couples a typical neural network architecture with external memory resources—analogous to a Turing Machine that uses tape for computation, storing data, and instructions. However, unlike a classical Turing Machine, a NTM is fully differentiable—meaning that the NTM can be trained end-to-end using gradient descent, which is a widely-used technique in machine learning. A NTM architecture contains two basic components: a neural network controller and an external memory bank (or memory matrix).

Consistent with most neural networks, the neural network (controller) interacts with the external world via input and output vectors. However, unlike a standard network, the controller also interacts with a memory using selective read and write operations via read/write heads. The memory is a matrix of vectors where each vector represents a memory slot. In a read operation, a read vector is generated by focusing on specific locations in the memory. The read vector is a weighted sum of the memory vectors, where the weights are determined by the controller. The writing operation is a two step process. In the first (erase) step, certain elements of the memory vectors are set to zero to effective remove old/irrelevant information. In the second (write) step, new information is written to the memory by updating the vectors with new values provided by the controller

Reference is made to FIG. 1, which illustrates aspects of the modified NTM 110. Like a typical NTM, the modified NTM 110 includes a controller (neural network) 110, read heads 130, write heads 135, and memory 140A, 140B. However, unlike a typical NTM architecture in which all of the memory is writable (i.e., changeable) using the write heads 135, the modified NTM architecture of the present design tool 100 includes both immutable (unchanging) memory 140A and mutable (changeable) memory 140B—both of which are readable by the read heads 130.

The immutable memory 140A is configured to include different types of criteria 150A-D that will be used to the new design 120. Although not limited in this manner, the different types of criteria include historical design criteria 150A, design system criteria 150B, User Experience/User Interface (UX/UI) criteria 150C, and application-related criteria 150D. Further descriptions of these criteria 150A-D are as follows.

### Historical Design Criteria

Historical design criteria 150A can include past designs that can be used as a reference (e.g., stored in a historical design database 320, as illustrated in FIG. 3). In particular, these past designs can be selected as containing design principles that are not explicitly stated. Although not limited in this manner, the past designs can be provided as LLM models.

### Design System Criteria

Design system criteria 150B can include three different components. A first component of the design system criteria 150B is global design specification. This includes the different levels of texts and the font/font size for each level of text. This can also include the default spacing between design elements. The second component of the design system criteria 150B is the design assets, and the design assets are typically defined by the assets within a UI component design library 315 of the design software used to create the application. This is typically available to designers. The third component of the design system criteria 150B is the component code library, which is an organized collection of pre-designed and pre-built user interface (UI) elements that can be reused across various project. Typically, there is a mapping between the component code library and the component library.

### UX/UI Criteria

Examples of User Experience/User Interface (UX/UI) criteria 150C include general or company-specific UX/UI requirements. These can include page depth limits, patent text quantity limits, and jump topology requirements. An example of a UX/UI criteria 150C would be the number of user controls (e.g., buttons) on a single page in a mobile application.

### Application-Related Criteria

Examples of application-related criteria 150D include the functionality requirements of the application itself as well as non-functional requirements. Additionally, application-related criteria 150D can include the existing system architecture in which the application executes, the types of data structures employed by the application, and the components with which the application interacts. Other application-related criteria 150D can also include the types of users with which the application interacts. This can include, for example, sophistication level of users and the type of privileges the users may possess.

The immutable memory 140A can also include component-specific feedback 155. The feedback 155 is not limited as to a particular form. For example, the feedback 155 can involve locking some aspect of the user interface. Another example of feedback 155 would involve commentary that identifies a particular change to a particular part of the user interface. Yet another example of feedback 155 would involve directions to merge multiple versions of a particular user interface. Other types of feedback 155 can also be used.

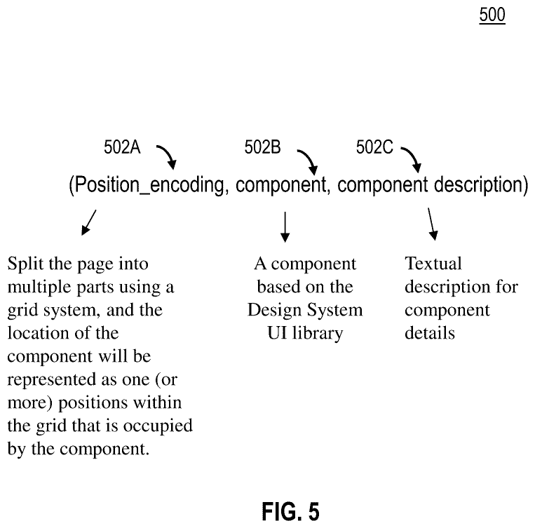

The mutable memory 140B is configured to store component descriptions 160. Although not limited in this manner, an example format of a particular component description 500 is illustrated in FIG. 5. In particular, the component description 500 can include three distinct portions: position encoding 502A, component identification 502B, and a component description 502C. The position encoding 502A can involve splitting the page (i.e., visible portion of the graphical user interface) into multiple parts (e.g., as a grid), and the location (or locations if the component overlaps multiple portions of the grid) of the component will be represented by the grid location. The component identification 502B can be mapped to a specific component found within the design system UI library. Additionally, the component description 502C can be a textual description of specific component details of the component.

Further aspects of the AI-powered design tool 300 and methodology 200 of using the same are illustrated in FIG. 3. The operations begin with the receipt of user input 325, which includes application context 327 and use case 329. This user input 325 does not necessarily vary from the type of prior user inputs typically used by prior neural networks for generating a page design for a graphical user interface of an application. For example, the user input 325 can describe the application's functionality, background, and any new requirements. This information is used to generate a use case 329. As an example, a use case 329 is a description of a new feature that is to be implemented in a standalone application or as an improvement to an existing application (e.g., allowing a user to book a hotel). The application context 327 can be other information that describes the context in which the application is used. For example, in a situation in which an improvement for an application is described, the application context 327 can describe currently-existing features of the application.

Based upon user input 325, the neural network 310 (e.g., using a contemporary large language model) can identify and/or generate example data 330 that includes both static information and dynamic information. This example data 330 is subsequently used, during the design process, to fill in the graphical user interface of the application being designed. Using the hotel booking example discussed above, example data 330 could include a picture of hotels, hotel names, hotel locations, prices of rooms, and room descriptions. The static information can be, for example, the labels associated with particular content (e.g., “Pictures of Hotels”), and the dynamic information can be the content itself, which is changeable (e.g., room pictures that change based upon a particular hotel being previously selected).

Using the example data 330, the neural network 310 can extract the dynamic information and output, as part of a technical design 335, a data model 340 that describes the example data 330. In certain aspects, the data model 340 is a database table of the different dynamic information that is to be displayed within the graphical user interface. The technical design 335 can be provided to an architect 345, who can provide feedback to modify the data model 340. For example, architect 345 can determine that the application for booking a hotel room needs additional information such as hotel addresses (where a hotel address was not previously included within the data model 340). By modifying the data model 340 to include the additional information (e.g., hotel address), the example data 330 can be subsequently modified using the neural network 310 to also include examples of the additional information. Although discussed in the context of removing additional information, the architect 345 can also provide feedback to remove certain information. In this manner, the architect 345 can fine tune how the graphical user interface design is generated by the neural network 310.

The neural network 310 can also use the input 325 to generate a user flow 350, which is how a user would navigate through the one or more pages of the application. The use of a neural network 310 to generate a user flow 350 is known, and the design tool 300 is not limited as to a particular approach for generating the user flow 350. For example, in the example in which the use case 329 is booking a hotel, the user flow 350 could include a user viewing a list of hotels in a list page, selecting one of the hotels (e.g., by clicking on a representation of the hotel in the user interface), bringing up details of the hotel (e.g., hotel description and hotel rooms), clicking on a particular hotel room, and then proceeding to a payment page.

The neural network 310 can also be configured to generate a page route 365, which is a description of how a user navigates along a single page of the user interface/application. Additionally, the neural network 310 is also configured to generate page entities 355, which are descriptions of the individual web pages within the application being traversed by a user.

The generation of the user flow 350, page entities 355, and page route 365 can be performed using a conventional neural network such as a large language model and the neural network 310 of the present design tool 300 is not limited in the manner in which this information is generated. However, while a large language model can be conventionally used to generate page content 360, the page content 360 is generated differently by the neural network 310 of the present design tool 300. Specifically, the example data 330 is used to populate the page content 360 of the user interface being designed.

The page content 360 and page route 365, as an initial version of the page design for the user interface and described using the component descriptions 160/500, is used as input into a self-criticism module 370. The self-criticism module 370 includes the specialized neural network 110 previously described with regard to FIG. 1. The output of the self-criticism module 370 is a new version of the page content 375 and a new version of the page route 380 and described using the component descriptions 160/500. Notably, the new page content 375 advantageously contains user interface assets consistent with the user interface assets stored within the UI component design library 315.

The new page content 375 and the new page route 380 is outputted as a design asset 385 that includes the new page design 390. This new page design 390 can be presented to a designer 395, who can provide feedback that subsequently gets returned back to the self-criticism module 370. Additionally, the new page content 375 and new page route 380 can be written into the mutable memory 140B and described using the component descriptions 160/500 and subsequently act as the prior page content 360 and prior page route 365, which can then be iteratively modified using the self-criticism module 370. As necessary, the self-criticism module 370 can also modify the example data 330 to be more consistent with feedback provided by the designer 395.

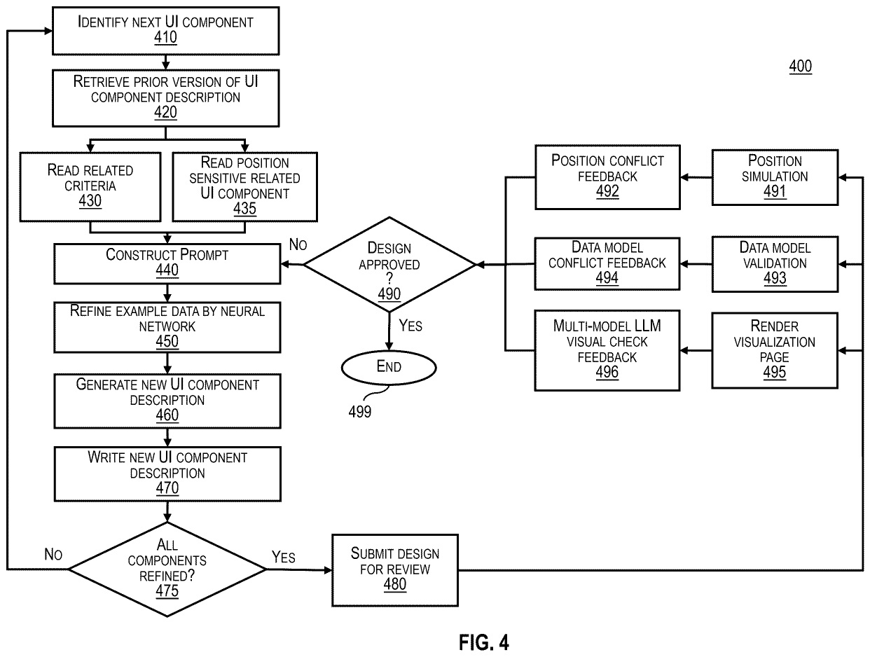

A further discussion of the design process 400 of using the neural network (either neural network 110 of FIG. 1 or self-criticism module 370 of FIG. 3) follows with reference to FIG. 4. In 410, the next UI component to be refined for the particular user interface/page being analyzed is selected, and in 420, a prior version of the selected UI component is retrieved from the mutable memory 140B.

In 430, based upon the selected UI component, the relevant criteria 150A-C is retrieved from the immutable memory 140A. This relevant criteria 150A-C can be selected using similarity scoring that compares the current/prior page content 360 and UI component description 500 to the information (e.g., criteria 150A-D and feedback 155) contained within the immutable memory 140A. Additionally, in 435, if the selected UI component is position-sensitive relative to other UI components, information regarding those other components are read.

In 440, a prompt for the neural network 110/370 is generated. In particular, the prompt is generated using the prior version of the component description 160/500 from the mutable memory 140B and the related criteria 150A-D from the immutable memory 140A. Optionally, the prompt can employ information regarding position-sensitive other UI components. Furthermore, the prompt can be constructed using feedback 155 from the prior version of the selected UI component.

In 450, the prompt can be provided to the neural network 110/370 and used refine the previously-generated example data 330, which is subsequently used to generate the data model 340.

In 460, the neural network generates a new UI component description 160/500 based upon the prompt. Notably, because the prompt was generated with the related criteria 150A-C from the immutable memory 140A, including criteria 150B associated with the UI component design library 315, the new UI component description 500 is also consistent with design assets provided by the UI component design library 315. In 470, that new UI component description 160/500 is written into the mutable memory 140B and can be subsequently used by the neural network 110/370 with further iterations of the design process 400.

In 475, a determination is made whether all of the UI components have been refined. If not, the process 400 returns back to 410 to select the next UI component. Otherwise, the page design 120/390 is submitted for review in 480. The review of the design 120/390 can be performed automatically and/or manually. For example, a review can be provided by the designer 395, who is then able to generate feedback. Additionally, automatically-generated types of review and feedback are possible. For example, a position simulation 491 can be performed that looks at the individual UI components within the user interface and determines whether the positions of the individual UI components conflict with one another. If so, position conflict feedback 492 can be created.

As another example, a data model validation 493 can be performed that reviews whether the data model 340 provides all of the information that is required for the new page design 120/390. If the data model 340 provides less (and/or more) data than required, data model conflict feedback 494 can be created. Additionally, in 495, a visual representation of the user interface/page can be generated that determines whether the page can be properly rendered. If not, visual check feedback 496 can be generated.

If the design 120/390 is approved in 490, the process ends at 499. Otherwise, the manual and/or automatic feedback 155 is provided back to the neural network 110/370 and used to iteratively generate a new design 120/390.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

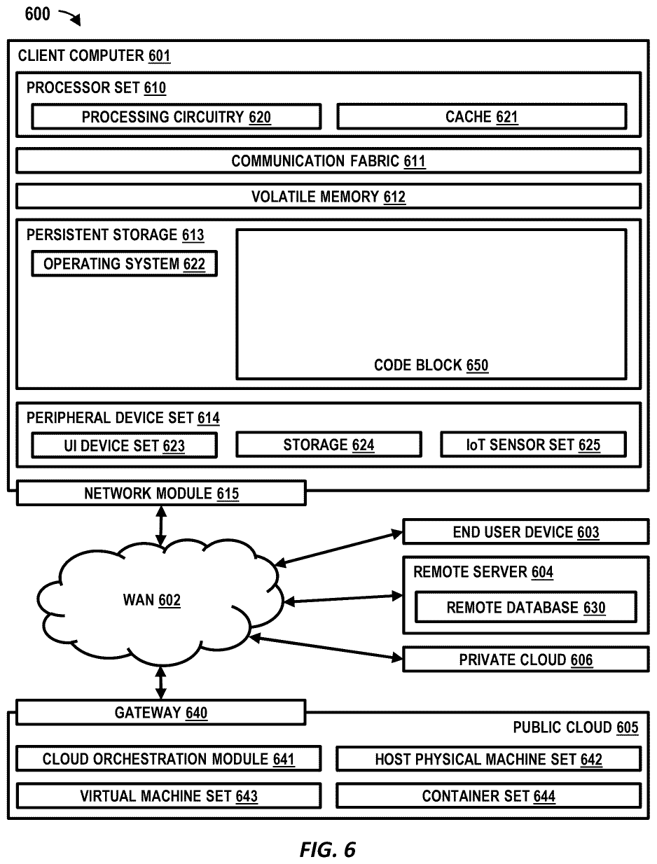

Referring to FIG. 6, computing environment 600 contains an example of an environment for the execution of at least some of the computer code involved in performing the inventive methods, such as code block 650 for implementing the operations of the design tool 100/300. Computing environment 600 includes, for example, computer 601, wide area network (WAN) 602, end user device (EUD) 603, remote server 604, public cloud 605, and private cloud 606. In certain aspects, computer 601 includes processor set 610 (including processing circuitry 620 and cache 621), communication fabric 611, volatile memory 612, persistent storage 613 (including operating system 622 and method code block 650), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. However, to simplify this presentation of computing environment 600, detailed discussion is focused on a single computer, specifically computer 601. Computer 601 may or may not be located in a cloud, even though it is not shown in a cloud in FIG. 6 except to any extent as may be affirmatively indicated.

Processor set 610 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In certain computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in code block 650 in persistent storage 613.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 611 is the signal conduction paths that allow the various components of computer 601 to communicate with each other. Typically, this communication fabric 611 is made of switches and electrically conductive paths, such as the switches and electrically conductive paths that make up busses, bridges, physical input/output ports and the like. Other types of signal communication paths may be used for the communication fabric 611, such as fiber optic communication paths and/or wireless communication paths.

Volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In computer 601, the volatile memory 612 is located in a single package and is internal to computer 601. In addition to alternatively, the volatile memory 612 may be distributed over multiple packages and/or located externally with respect to computer 601.

Persistent storage 613 is any form of non-volatile storage for computers that is now known or to be developed in the future. The non-volatility of the persistent storage 613 means that the stored data is maintained regardless of whether power is being supplied to computer 601 and/or directly to persistent storage 613. Persistent storage 613 may be a read only memory (ROM), but typically at least a portion of the persistent storage 613 allows writing of data, deletion of data and re-writing of data. Some familiar forms of persistent storage 613 include magnetic disks and solid state storage devices. Operating system 622 may take several forms, such as various known proprietary operating systems or open source Portable Operating System Interface type operating systems that employ a kernel. The code included in code block 650 typically includes at least some of the computer code involved in performing the inventive methods.

Peripheral device set 614 includes the set of peripheral devices for computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some aspects, storage 624 may take the form of a quantum computing storage device for storing data in the form of qubits. In aspects where computer 601 is required to have a large amount of storage (for example, where computer 601 locally stores and manages a large database) then this storage 624 may be provided by peripheral storage devices designed for storing very large amounts of data, such as a storage area network (SAN) that is shared by multiple, geographically distributed computers. Internet-of-Things (IoT) sensor set 625 is made up of sensors that can be used in IoT applications. For example, one sensor may be a thermometer and another sensor may be a motion detector.

Network module 615 is the collection of computer software, hardware, and firmware that allows computer 601 to communicate with other computers through a Wide Area Network (WAN) 602. Network module 615 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 615 are performed on the same physical hardware device. In other aspects (for example, aspects that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any Wide Area Network (for example, the internet) capable of communicating computer data over non-local distances by any technology for communicating computer data, now known or to be developed in the future. In some aspects, the WAN 602 ay be replaced and/or supplemented by local area networks (LANs) designed to communicate data between devices located in a local area, such as a Wi-Fi network. The WAN 602 and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In certain aspects, EUD 603 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. As defined herein, the term “server” means a data processing system configured to share services with one or more other data processing systems.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other aspects, a private cloud 606 may be disconnected from the internet entirely (e.g., WAN 602) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method of generating a graphical user interface (GUI) design for an application using a neural network connected to an immutable memory and a mutable memory, comprising:
receiving an input defining requirements for the application;
populating the immutable memory using the requirements;
populating the mutable memory with previous component descriptions for UI components;
generating, by the neural network using the immutable memory and the mutable memory and responsive to a prompt, a new component description for a UI component of the GUI, wherein
the neural network is a neural Turing machine.

2. The method of claim 1, wherein
the new component description is generated using data from the immutable memory including:
historical design criteria,
design system criteria,
user interface (UX)/UI criteria, and
application-related criteria.

3. The method of claim 1, wherein
the requirements include application context and use case,
example data for the GUI is generated from the use case, and
a data model for the GUI is generated from the example data.

4. The method of claim 3, wherein
the data model is used to generate the prompt for the neural network.

5. The method of claim 1, wherein
the generating the new component description for the UI component includes:
identifying a previous version of the component description in the mutable memory,
identifying, within the immutable memory, criteria associated with the UI component,
constructing the prompt using the criteria associated with the UI component, and
writing the new component description to the mutable memory.

6. The method of claim 5, wherein
feedback from a prior page design is used to construct the prompt.

7. The method of claim 6, wherein
the feedback from the prior page design includes at least one of:
position conflict feedback,
data model conflict feedback, and
visual check feedback.

8. The method of claim 1, wherein
the immutable memory is populated using information associated with the user interface (UI) component design library, and
the new component description is consistent with the UI component design library.

9. The method of claim 1, wherein
a component description for a particular UI component includes:
a position encoding that identifies a physical position of the particular UI component within the GUI,
an identification of the particular UI component within the UI component design library, and
a textual description of the particular UI component.

10. A computer hardware system for generating a graphical user interface (GUI) design for an application, comprising:
an immutable memory;
a mutable memory;
a neural network connected to the immutable memory and the mutable memory, and
a hardware processor configured to initiate the following executable operations:
receiving an input defining requirements for the application;
populating the immutable memory using the requirements and a user interface (UI) component design library;
populating the mutable memory with previous component descriptions for UI components;
generating, by the neural network using the immutable memory and the mutable memory and responsive to a prompt, a new component description for a UI component of the GUI, wherein
the neural network is a neural Turing machine.

11. The system of claim 10, wherein
the new component description is generated using data from the immutable memory including:
historical design criteria,
design system criteria,
user interface (UX)/UI criteria, and
application-related criteria.

12. The system of claim 10, wherein
the requirements include application context and use case,
example data for the GUI is generated from the use case, and
a data model for the GUI is generated from the example data.

13. The system of claim 12, wherein
the data model is used to generate the prompt for the neural network.

14. The system of claim 10, wherein
the generating the new component description for the UI component includes:
identifying a previous version of the component description in the mutable memory,
identifying, within the immutable memory, criteria associated with the UI component,
constructing the prompt using the criteria associated with the UI component, and
writing the new component description to the mutable memory.

15. The system of claim 14, wherein
feedback from a prior page design is used to construct the prompt.

16. The system of claim 15, wherein
the feedback from the prior page design includes at least one of:
position conflict feedback,
data model conflict feedback, and
visual check feedback.

17. The system of claim 10, wherein
the immutable memory is populated using information associated with the user interface (UI) component design library, and
the new component description is consistent with the UI component design library.

18. The system of claim 10, wherein
a component description for a particular UI component includes:
a position encoding that identifies a physical position of the particular UI component within the GUI,
an identification of the particular UI component within the UI component design library, and
a textual description of the particular UI component.

19. A computer program product, comprising:
a computer readable storage medium having stored therein program code for generating a graphical user interface (GUI) design for an application,
the program code, which when executed by a computer hardware system including a neural network connected to an immutable memory and a mutable memory, causes the computer hardware system to perform:
receiving an input defining requirements for the application;
populating the immutable memory using the requirements and a user interface (UI) component design library;
populating the mutable memory with previous component descriptions for UI components;
generating, by the neural network using the immutable memory and the mutable memory and responsive to a prompt, a new component description for a UI component of the GUI, wherein
the neural network is a neural Turing machine.

20. The computer program product of claim 19, wherein
the generating the new component description for the UI component includes:
identifying a previous version of the component description in the mutable memory,
identifying, within the immutable memory, criteria associated with the UI component,
constructing the prompt using the criteria associated with the UI component, and
writing the new component description to the mutable memory.
